(19) United States
(12) Patent Application Publication
(10) Pub. No.: US 2026/0308829 A1
(43) Pub. Date: Oct. 8, 2026

(54) METHOD FOR MANUFACTURING FIBER-RESIN COMPOSITE MATERIAL, METHOD FOR MANUFACTURING MOBILE PHONE CASE, AND MOBILE PHONE CASE

(71) Applicant: SHENZHEN LINGYI INNOVATION TECHNOLOGY CO., LTD., SHENZHEN (CN)

(72) Inventors: Jiali YU, SHENZHEN (CN); Zhenhui YU, SHENZHEN (CN); Yanghui ZHENG, SHENZHEN (CN)

(73) Assignee: SHENZHEN LINGYI INNOVATION TECHNOLOGY CO., LTD., SHENZHEN (CN)

(21) Appl. No.: 19/679,778

(22) Filed: May 18, 2026

Related U.S. Application Data
(63) Continuation of application No. PCT/CN2024/113071, filed on Aug. 19, 2024.

(30) Foreign Application Priority Data
Nov. 16, 2023 (CN) 202311536792.X

(51) Int. Cl. D06B 5/22; D06M 15/564; D06M 101/36

(52) U.S. Cl. CPC D06B 5/22; D06M 15/564; D06M 2101/36; D10B 2331/021

(57) ABSTRACT

A method for manufacturing a fiber-resin composite material includes: obtaining an aramid fiber woven fabric having a grammage of 100 g/m² to 350 g/m² and having N stacked layers, as a base material, where the N is a positive integer greater than or equal to 1; obtaining a resin having a Shore hardness of 30 A and 85D as a composite layer, and performing full or semi-pre-impregnation on the composite layer and the base material, so as to obtain a semi-finished fiber-resin composite material; performing hot pressing on the semi-finished fiber-resin composite material, where a hot pressing temperature is 150° C. to 250° C., a hot pressing pressure is 40 bar to 55 bar, and a hot pressing duration is 2 min to 10 min; after performing the hot pressing for a preset hot pressing duration, stopping heating the semi-finished fiber-resin composite material, so as to obtain a fiber-resin composite material.

### CROSS REFERENCE TO RELATED APPLICATIONS

The present application is a continuation application of the international patent application PCT/CN2024/113071, filed on Aug. 19, 2024, which claims the priority of the Chinese patent application No. 202311536792.X, filed on Nov. 16, 2023, contents of which are incorporated herein by its entireties.

### TECHNICAL FIELD

Embodiments of the present disclosure relate to the technical field of mobile phone cases, and more specifically, to a method for manufacturing a fiber-resin composite material, a method for manufacturing a mobile phone case, and a mobile phone case.

### BACKGROUND

An aramid fiber mobile phone case may be a type of mobile phone case made of an aramid fiber-resin composite material, which may exhibit excellent wear resistance and impact resistance. For the aramid fiber-resin composite material in the art, high-hardness resin may be used, such as thermosetting epoxy resin. After pre-impregnation and curing, the high-hardness resin may have certain hardness and may not be easily bent or folded. When using the aramid fiber-resin composite material to manufacture a full-coverage mobile phone case, due to the high hardness of the mobile phone case, it may be difficult for a user to install a phone into the mobile phone case or remove a phone out of the mobile phone case. Therefore, the above technical problem may need to be solved.

### SUMMARY

In order to solve the above technical problem, the present disclosure provides a method for manufacturing a fiber-resin composite material, including following blocks.

In a block S10, obtaining an aramid fiber woven fabric as a base material, wherein the aramid fiber woven fabric has a grammage in a range of 100 g/m² to 350 g/m², and the aramid fiber woven fabric has N stacked layers, the N is a positive integer greater than or equal to 1.

In a block S20, obtaining a resin having a Shore hardness in a range of 30 A to 85 D as a composite layer, and performing full pre-impregnation or semi-pre-impregnation on the composite layer and the base material, so as to obtain a semi-finished fiber-resin composite material.

In a block S30, placing the semi-finished fiber-resin composite material in a hot pressing device for hot pressing, enabling the resin to penetrate into gaps of the aramid fiber woven fabric, wherein a temperature of the hot pressing in the hot pressing device is in a range of 150° C. to 250° C., a pressure of the hot pressing is in a range of 40 bar to 55 bar, and a duration of the hot pressing is in a range of 2 min to 10 min.

In a block S40, after the hot pressing performed on the semi-finished fiber-resin composite material for a preset hot pressing duration, stopping heating the semi-finished fiber-resin composite material, so as to obtain a finished fiber-resin composite material.

The present disclosure further provides a method for manufacturing a mobile phone case, including the following:
S100, obtaining a fiber-resin composite material as a first sheet material, wherein the fiber-resin composite material is manufactured by the method for manufacturing the fiber-resin composite material according to any one of claims 1 to 5;
S200, cutting the first sheet material to obtain a preset sheet material in a preset size and in a preset shape, wherein, the preset sheet material comprises a central region and an edge region surrounding the central region;
S300, obtaining a semi-cured material or a cured material as a second sheet material, attaching the second sheet material to the central region of the preset sheet material, and placing the second sheet material together with the preset sheet material into a mobile phone case mold;
S400, performing secondary molding on the second sheet material and the preset sheet material, wherein a temperature of the secondary molding is in a range of 160° C. to 200° C., a pressure of the secondary molding is in a range of 35 bar to 45 bar, and a duration of the secondary molding is in a range of 5 min to 15 min;
S500, after the duration of the secondary molding performed on the second sheet material and the preset sheet material reaching a preset molding duration, cooling the second sheet material and the preset sheet material to a room temperature, so as to obtain a finished mobile phone case.

The present disclosure further provides a mobile phone case, comprising: a body portion made of a fiber-resin composite material and a reinforcing portion made of a semi-cured material or a cured material. The body portion comprises a carrying portion for contacting a rear of a phone and a wrapping portion for wrapping sides of the phone; the reinforcing portion is disposed on the carrying portion; the fiber-resin composite material comprises an aramid fiber woven fabric layer and a resin composite layer; the aramid fiber woven fabric layer comprises 1 layer to 5 stacked layers of aramid fiber woven fabric, the aramid fiber woven fabric layer has a grammage in a range of 100 g/m² to 350 g/m², and the resin composite layer has a Shore hardness in a range of 80 A to 80 D.

### BRIEF DESCRIPTION OF THE DRAWINGS

In order to more clearly illustrate technical solutions in embodiments of the present disclosure, accompanying drawings used in the embodiments will be briefly introduced below. Obviously, the accompanying drawings in the following description show only some of the embodiments of the present disclosure, and any ordinary skilled person in the art may obtain other accompanying drawings based on these drawings without creative work.

FIG. 1 is a flow chart of a method for manufacturing a fiber-resin composite material according to an embodiment of the present disclosure.

FIG. 2 is a flow chart of a block S20 shown in FIG. 1, according to an embodiment of the present disclosure.

FIG. 3 is a flow chart of the block S20 shown in FIG. 1, according to another embodiment of the present disclosure.

FIG. 4 is a flow chart of a method for manufacturing a mobile phone case according to an embodiment of the present disclosure.

FIG. 5 is a cross-sectional view of the mobile phone case according to an embodiment of the present disclosure.

FIG. 6 is a structural schematic view of a body portion of the mobile phone case in FIG. 5.

FIG. 7 is a cross-sectional view of the body portion of the mobile phone case shown in FIG. 6, according to an embodiment of the present disclosure.

FIG. 8 is a cross-sectional view of the body portion of the mobile phone case shown in FIG. 6, according to another embodiment of the present disclosure.

### REFERENCE NUMERALS IN THE DRAWINGS

Table 1_sm_0001

| Reference numerals | Element |
|---|---|
| 100 | Mobile phone case |
| 110 | Body portion |
| 110a | Carrying portion |
| 110b | Wrapping portion |
| 111 | aramid fiber woven fabric layer |
| 112 | resin composite layer |
| 113 | TPU resin composite layer |
| 120 | reinforcing portion |

Achievement, functional characteristics, and advantages of the present disclosure will be further described by referring to embodiments and accompanying drawings.

### DETAILED DESCRIPTIONS

The technical solutions in the embodiments of the present disclosure will be clearly and completely described below by referring to the accompanying drawings in the embodiments of the present disclosure. Apparently, the described embodiments are only a part of, not all of, the embodiments of the present disclosure. All other embodiments, which are obtained by any ordinary skilled artisan in the art based on the embodiments in the present disclosure without creative work, shall fall within the scope of the present disclosure.

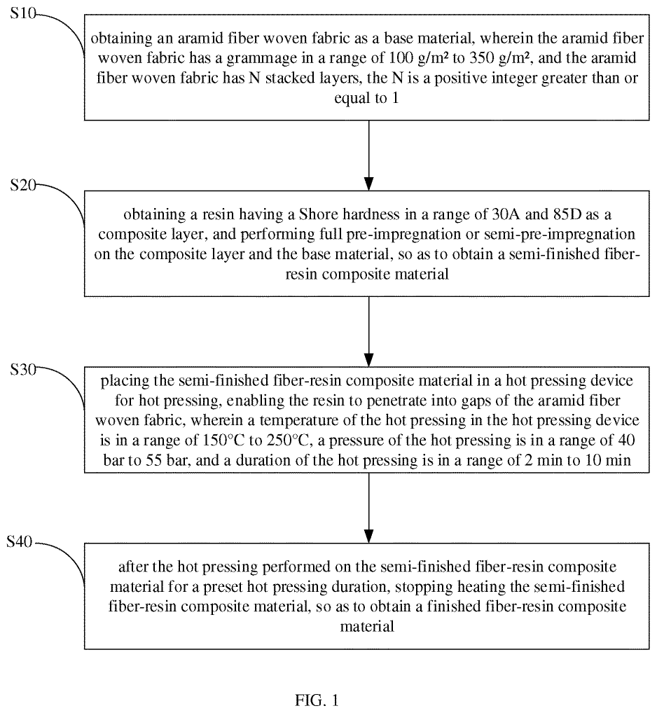

As shown in FIG. 1, the present disclosure may provide a method for manufacturing a fiber-resin composite material, including the following blocks.

In a block S10, an aramid fiber woven fabric may be obtained as a base material. The aramid fiber woven fabric may have a grammage in a range of 100 g/m² to 350 g/m², and the aramid fiber woven fabric may have N layers stacked, the N may be a positive integer greater than or equal to 1.

The aramid fiber woven fabric may be formed by weaving aramid fibers. The aramid fibers may be a new type of high-tech synthetic fiber having excellent properties, such as having ultra-high strength and a light weight, being insulated, and having aging resistance. Therefore, the aramid fiber woven fabric may also have the same excellent properties, having ultra-high strength and a light weight, being insulated, and having aging resistance.

The grammage of the aramid fiber woven fabric may be in the range of 100 g/m² to 350 g/m², and that is, the grammage of the aramid fiber woven fabric may be 100 g/m², 120 g/m², 140 g/m², 160 g/m², 180 g/m², 200 g/m², 220 g/m², 240 g/m², 260 g/m², 280 g/m², 300 g/m², 320 g/m², 340 g/m², 350 g/m², or any other value. In this way, the grammage of the aramid fiber woven fabric may be determined according to a weight of the mobile phone case.

The number of stacked layers N of the aramid fiber woven fabric may be the positive integer greater than or equal to 1. That is, the number of stacked layers may be 1, 2, 3, 4, 5, 6, and so on. A total weight of the aramid fiber woven fabric may be positively proportional to the number of stacked layers. In this way, the number of stacked layers of the aramid fiber woven fabric may be determined based on the weight and strength of the mobile phone case.

To be noted that, since the grammage and the number of stacked layers of the aramid fiber woven fabric may not be fixed values, a weight of the base material may be adjusted by adjusting the grammage and the number of stacked layers of the aramid fiber woven fabric. In this way, adaptive selection may be made based on a thickness and the weight of the mobile phone case.

In a block S20, a resin having a Shore hardness in a range of 30 A to 85 D may be obtained as a composite layer, full pre-impregnation or semi-pre-impregnation may be performed on the composite layer and the base material, so as to obtain a semi-finished fiber-resin composite material.

A plurality of types of resins may have the Shore hardness in a range of 30 A to 85 D, such as a thermoplastic polyurethane elastomer (TPU) resin, a thermoplastic elastomer (TPE) resin, and so on. The fiber-resin composite material, which is obtained by performing the full pre-impregnation on the resin and the aramid fiber woven fabric, may have relatively high hardness. The fiber-resin composite material, which is obtained by performing the semi-pre-impregnation on the resin and the aramid fiber woven fabric, may have relatively lower hardness.

In addition, a degree of impregnation of the resin and the aramid fiber woven fabric may be related to a temperature, a pressure, and a duration of the impregnation. Specifically, the degree of impregnation may be positively correlated with the temperature, the pressure, and the duration. Therefore, the degree of impregnation may be adjusted by adjusting the temperature, the pressure, and the duration of the impregnation, such that the hardness of the fiber-resin composite material may be adjusted.

That is, the hardness of the fiber-resin composite material may be adjusted not only by combining the resin with the aramid fiber woven fabric, but also by adjusting the temperature, the pressure, and the duration for combining the resin with the aramid fiber woven fabric. In this way, the fiber-resin composite material with a desired hardness may be obtained by adjusting the process and parameters of combining the resin and the aramid fiber woven fabric.

In a block S30, the semi-finished fiber-resin composite material may be placed in a hot pressing device for hot pressing, such that the resin may penetrate into gaps of the aramid fiber woven fabric. A hot pressing temperature of the hot pressing device may be in a range of 150° C. to 250° C., a pressure of the hot pressing may be in a range of 40 bar to 55 bar, and a duration of the hot pressing may be in a range of 2 min to 10 min.

The hot pressing device may be a vacuum hot pressing tank, a flat plate hot press, and so on.

The hot pressing device may be configured perform hot pressing on the semi-finished fiber-resin composite material. The hot pressing device may heat the semi-finished fiber-resin composite material to 150° C., 160° C., 170° C., 180° C., 190° C., 200° C., 210° C., 220° C., 230° C., 240° C., 250° C., or other temperatures. The hot pressing device may further apply a pressure of 40 bar, 42 bar, 44 bar, 46 bar, 48 bar, 50 bar, 52 bar, 54 bar, 55 bar, or other pressures, to the semi-finished fiber-resin composite material. The hot pressing may perform hot pressing on the semi-finished fiber-resin composite material for 2 min, 3 min, 5 min, 8 min, 10 min, and so on.

To be noted that, the hot pressing temperature, the hot pressing pressure, and the hot pressing duration applied on the semi-finished fiber-resin composite material may all affect the degree of impregnation of the resin and the aramid fiber woven fabric in the semi-finished product. Specifically, within the application scope of the present disclosure, the degree of impregnation of the resin and the aramid fiber woven fabric may be positively correlated with the hot pressing temperature, the hot pressing pressure, and the hot pressing duration. Therefore, the degree of impregnation may be adjusted by adjusting the hot pressing temperature, the hot pressing pressure, and the hot pressing duration, so as to obtain the semi-finished fiber-resin composite material with a suitable degree of impregnation, such that the fiber-resin composite material with an appropriate hardness may be obtained. For the present disclosure, since ranges of the temperature and the pressure may fall within a rated working range of a flat plate hot press, the flat plate hot press may be used to achieve more precise control in the temperature, the pressure, and the duration, resulting in the fiber-resin composite material in better quality.

In a block S40, after the hot pressing device performs the hot pressing on the semi-finished fiber-resin composite material for a preset hot pressing duration, heating the semi-finished fiber-resin composite material may be stopped, so as to obtain the finished fiber-resin composite material.

After the hot pressing device performs the hot pressing on the semi-finished fiber-resin composite material for the preset hot pressing duration, heating may be stopped. The semi-finished fiber-resin composite material that is hot pressed by the hot pressing device may be cooled to the room temperature by natural cooling. The above operation may consume a certain amount of time. Of course, the semi-finished fiber-resin composite material that is hot pressed by the hot pressing device may alternatively be cooled to the room temperature by water cooling or by a machine with temperature adjustment. For a cooling manner thereof, the temperature may be changed in gradient, or changed in a curved manner, or changed linearly. The semi-finished fiber-resin composite material that is hot pressed by the hot pressing device may become the finished fiber-resin composite material when cooled to the room temperature.

According to the method for manufacturing the fiber-resin composite material of the present disclosure, the aramid fiber woven fabric, having the grammage of 100 g/m² to 350 g/m² may be used as the base material, and the resin, having the Shore hardness in a range of 30 A to 85 D, may be used as the composite layer. Full pre-impregnation or semi-pre-impregnation may be performed on the base material and the composite layer, so as to form the semi-finished fiber-resin composite material. The semi-finished fiber-resin composite material may be hot-pressed in the hot pressing device and cooled to form the finished fiber-resin composite material. The fiber-resin composite material manufactured by the above method may have ideal strength and flexibility. For the mobile phone case manufactured using the above fiber-resin composite material, a bottom plate and four side plates may be integrally formed with each other and provide full coverage, such that four sides of the phone may be completely wrapped. Furthermore, the fiber-resin composite material may have certain flexibility, facilitating the phone to be installed into and removed out of the mobile phone case. In addition, the fiber-resin composite material may have ideal wear resistance, ensuring a service life of the mobile phone case.

To be noted that the weight of the mobile phone case may not be excessively large. Therefore, when obtaining the aramid fiber woven fabric, the grammage and the number of stacked layers may be considered. In some embodiments of the present disclosure, the grammage of the aramid fiber woven fabric may be negatively correlated with the number of stacked layers of the aramid fiber woven fabric. That is, a value of the N may be negatively correlated with the grammage of the aramid fiber woven fabric, wherein 1≤N≤5. In this way, when selecting the aramid fiber woven fabric, the aramid fiber woven fabric with a large grammage and a large number of stacked layers may not be used, such that the mobile phone case may not be excessive heavy.

In some embodiments of the present disclosure, the aramid fiber woven fabric may have the grammage of 300±50 g/m², i.e., in a range of 250 g/m² to 350 g/m². The aramid fiber woven fabric may have 1 to 3 stacked layers, i.e., 1 layer, or 2 stacked layers, or 3 stacked layers. The composite layer may be the resin having the Shore hardness of 80 A to 50 D. In this way, the composite layer may have a relatively high hardness, the thickness of the fiber-resin composite material may be reduced by decreasing the number of stacked layers of the aramid fiber woven fabric, such that the mobile phone case may be thin, and at the same time, may provide ideal wrapping performance.

In some embodiments of the present disclosure, the aramid fiber woven fabric may have the grammage of 150±15 g/m², i.e., in a range of 135 g/m² to 165 g/m²; the aramid fiber woven fabric may have 3 to 5 stacked layers, i.e., 3 stacked layers, 4 stacked layers, or 5 stacked layers; the composite layer may be the resin having the Shore hardness of 90 A to 65 D. In this way, since the composite layer may have a relatively low hardness, the number of stacked layers of the aramid fiber woven fabric may be increased to increase an overall thickness of the fiber-resin composite material, such that the mobile phone case may have a moderate hardness, and at the same time, may provide ideal wrapping performance.

It should be noted that if the hardness of the resin for the composite layer is excessively low, the number of stacked layers of the aramid fiber woven fabric required for the base material may be high, resulting in a relatively thick fiber-resin composite material. Accordingly, in some embodiments of the present disclosure, the composite layer may be the resin having the Shore hardness of 80 A to 80 D, allowing a smaller number of stacked layers of the aramid fiber woven fabric to be used. A thickness of each layer of the finished fiber-resin composite material may be limited to in a range of 0.15 mm to 1 mm. Of course, the total thickness after the layers being stacked may be related to the number of stacked layers. In this way, both the wear resistance and flexibility of the fiber-resin composite material may be ensured, and the thickness of the fiber-resin composite material may not be excessively large.

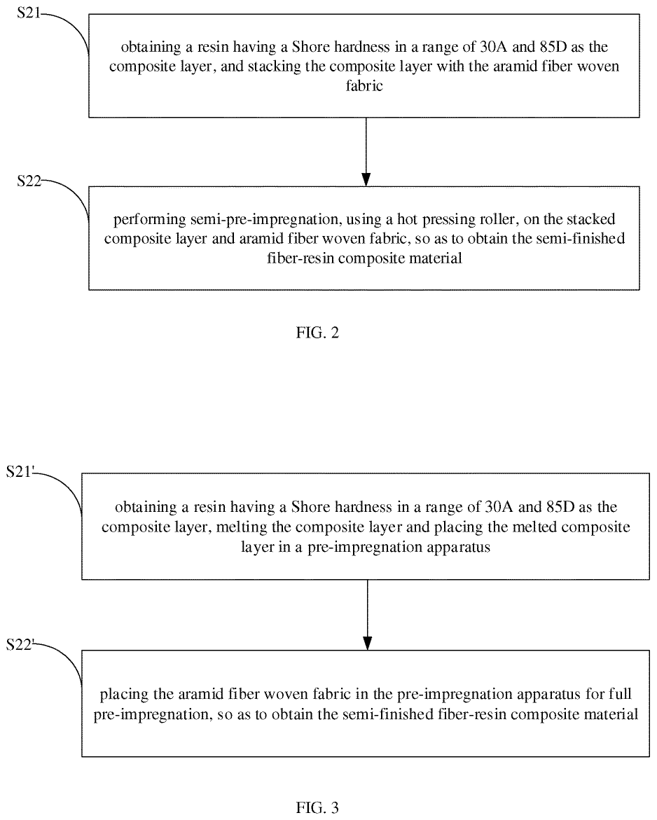

In some embodiments of the present invention, the composite layer and the base material may be semi-pre-impregnated. As shown in FIG. 2, the block S20 may include the following.

In a block S21, the resin having the Shore hardness in a range of 30 A to 85 D may be obtained as the composite layer, and the composite layer may be stacked with the aramid fiber woven fabric. In a block S22, semi-pre-impregnation may be performed, using a hot pressing roller, on the composite layer and aramid fiber woven fabric that are stacked, so as to obtain the semi-finished fiber-resin composite material.

In the present embodiment, the resin having the Shore hardness in a range of 30 A to 85 D may be a TPE resin film. When the TPE resin film and the aramid fiber woven fabric are hot-pressed and combined with each other by the hot pressing roller, the resulting semi-finished fiber-resin composite material may have certain flexibility and wear resistance. The finished product of the fiber-resin composite material obtained by the above combining process may have high flexibility. In this way, the mobile phone case made from the fiber-resin composite material may completely wrap the phone, and the aramid fiber woven fabric with the higher grammage may provide sufficient wear resistance.

In other embodiments of the present disclosure, when the composite layer and the base material are fully pre-impregnated, as shown in FIG. 3, the block S20 may include the following.

In a block S21′, the resin having the Shore hardness in a range of 30 A to 85 D may be obtained as the composite layer, the composite layer may be melted in a pre-impregnation apparatus.

In a block S22′, the aramid fiber woven fabric may be placed in the pre-impregnation apparatus for full pre-impregnation, so as to obtain the semi-finished fiber-resin composite material.

In the present embodiment, the resin having the Shore hardness in a range of 30 A to 85 D may be TPU resin. In this case, full pre-impregnation may be performed on the base material and the composite layer, allowing the TPU resin to fully impregnate two layers of the aramid fiber woven fabric. In this way, the hardness of the finished fiber-resin composite material may be ensured, the fiber-resin composite material may have a reduced thickness. In addition, the finished fiber-resin composite material obtained in this way may have certain flexibility, and wear resistance performance of the aramid fiber mobile phone case may be maintained, such that performance of the mobile phone case made from the fiber-resin composite material may be ensured.

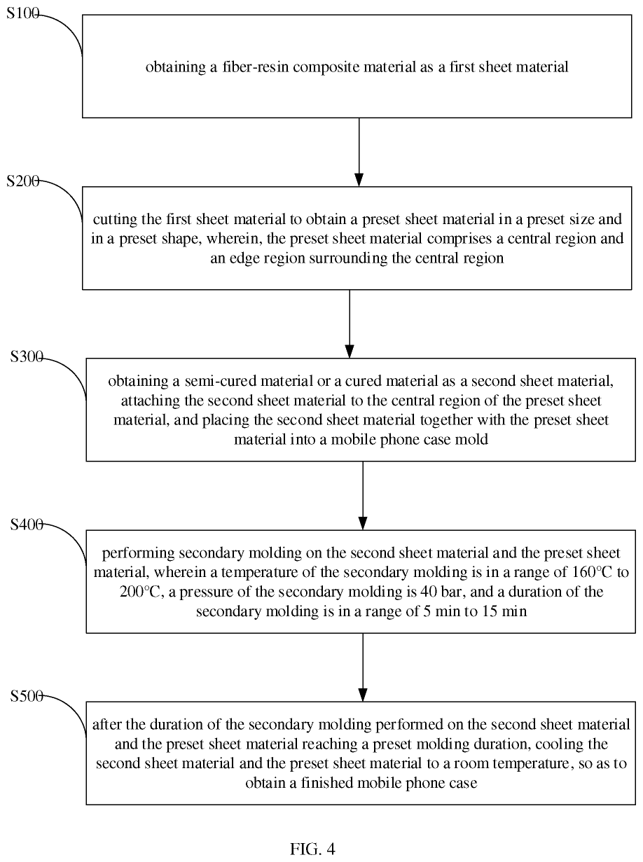

As shown in FIG. 4, the present disclosure may further provide a method for manufacturing a mobile phone case, including the following blocks.

In a block S100, the fiber-resin composite material may be obtained as a first sheet material, and the fiber-resin composite material may be obtained by performing the method for manufacturing the fiber-resin composite material as described above.

The method for manufacturing the fiber-resin composite material may refer to the above embodiments. The hardness of the fiber-resin composite material may be determined as needed by using the aramid fiber woven fabric with a desired grammage and the resin with a desired hardness. In some embodiments, the hardness of the resin may be in the range of 50 D to 85 D. In this way, the number of stacked layers of the aramid fiber woven fabric may be reduced, and the thickness of each layer of the fiber-resin composite material may be limited to 0.15 mm to 1 mm, such that the thickness of the mobile phone case may not be excessively large.

In a block S200, the first sheet material may be cut to obtain a preset sheet material in a preset size and a preset shape. The preset sheet material may include a central region and an edge region surrounding the central region.

The fiber-resin composite material may be cut by a laser cutting machine or a cutting machine tool to obtain the preset sheet material in the preset size and the preset shape. In some embodiments, the preset sheet material may be rectangular, elongated-circular, or in any other shape, which is not specifically limited here. The preset sheet material may include the central region and the edge region surrounding the central region. The central region of the preset sheet material may be molded to form a body portion 110 of the mobile phone case. The edge region of the preset sheet material may be molded to form a wrapping portion of the mobile phone case.

In a block S300, a semi-cured material or a cured material may be obtained as a second sheet material. The second sheet material may be attached to the central region of the preset sheet material, and the second sheet material and the preset sheet material may both be placed onto a mobile phone case mold.

When the second sheet material is formed of the semi-cured material, the second sheet material may be a fiberglass board (glass fiber board) or other materials. When the second sheet material is formed of the cured material, the second sheet material may be a carbon fiber board, a stainless steel board, a polycarbonate board (PC board), or other materials. The specific material for the second sheet material may be determined according to actual requirements. By arranging the second sheet material, strength of the mobile phone case at a position contacting a rear side of the phone may be improved.

In a block S400, a molding process may be performed on the second sheet material and the preset sheet material to achieve secondary molding, a temperature of the secondary molding may be in a range of 160° C. to 200° C., a pressure of the secondary molding may be in a range of 35 bar to 45 bar, and a duration of the secondary molding may be in a range of 5 min to 15 min.

The temperature of the secondary molding may be 160° C., 165° C., 170° C., 175° C., 180° C., 185° C., 190° C., 195° C., 200° C., and so on. The pressure of the secondary molding may be 35 bar, 36 bar, 37 bar, 38 bar, 39 bar, 40 bar, 41 bar, 42 bar, 43 bar, 44 bar, 45 bar, and so on. The duration of the secondary molding may be 5 min, 6 min, 7 min, 8 min, 9 min, 10 min, 11 min, 12 min, 13 min, 14 min, 15 min, and so on. The temperature of the secondary molding, the pressure of the secondary molding, and the duration of the secondary molding may be related to a required shaping temperature and a required shaping pressure for the preset sheet material, and may be related to a combining temperature and a combining pressure for the preset sheet material and the second sheet material.

Since the second sheet material is attached to the central region of the preset sheet material and placed together with the preset sheet material onto the mobile phone case mold, after performing the secondary molding on the second sheet material and the preset sheet material, the preset sheet material may be pressed into the shape of the mobile phone case, and the second sheet material may be integrally connected with a portion of the preset sheet material forming the bottom plate of the mobile phone case. In this way, by performing the secondary molding, the preset sheet material may be molded to be shaped into the mobile phone case, and the preset sheet material and the second sheet material may be integrally connected to each other, such that a manufacturing process of the mobile phone case may be simplified.

In a block S500, after the duration of the secondary molding performed on the second sheet material and the preset sheet material reaches a preset molding duration, the second sheet material and the preset sheet material may be cooled to the room temperature, so as to obtain a finished mobile phone case.

The second sheet material and the preset sheet material may be cooled in various ways. The second sheet material and the preset sheet material may be cooled to the room temperature by natural cooling, by water cooling or air cooling, or by equipment with temperature adjustment. During cooling, the temperature may be changed in gradient, in a curved manner, or changed linearly, which is not specifically limited here. After the second sheet material and the preset sheet material are cooled to the room temperature, the preset sheet material may be solidified and may be integrally formed with the second sheet material, such that the finished mobile phone case may be formed.

According to the method for manufacturing the mobile phone case of the present disclosure, the fiber-resin composite material may be obtained as the first sheet material, and the semi-cured material or the cured material may be obtained as the second sheet material. The second sheet material may be attached to the preset sheet material, which may be obtained by cutting the first sheet material. The second sheet material and the preset sheet material may be placed in the mobile phone case mold, and may be subjected to the secondary molding, so as to form the mobile phone case. The bottom plate and four side plates of the mobile phone case manufactured by the above method may be integrally formed as a one-piece structure. The four side plates may have a same height. In this way, complete wrapping of the phone by the four sides may be achieved. In addition, the fiber-resin composite material may have the certain flexibility, allowing the four side plates to be deformed under external force, facilitating the phone to be installed into and removed out of the mobile phone case. Furthermore, the flexibility of the fiber-resin composite material may ensure that the four side plates of the mobile phone case can conform to four sides of the phone corresponding.

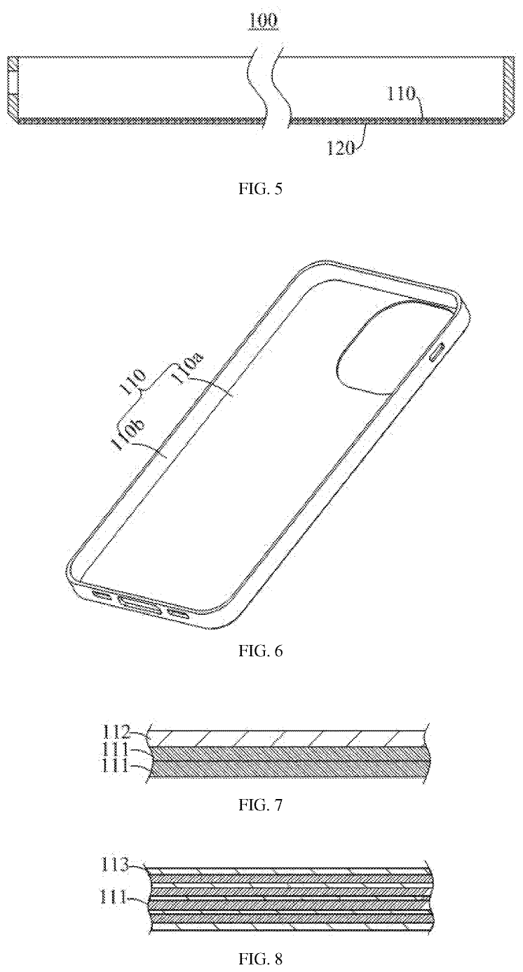

As shown in FIGS. 5 and 6, the present disclosure may further provide a mobile phone case 100. The mobile phone case 100 may include a body portion 110 and a reinforcing portion 120. The body portion may include a carrying portion 110a for contacting the rear of the phone and a wrapping portion 110b for wrapping the sides of the phone. The body portion 110 may be made of the fiber-resin composite material. The reinforcing portion 120 may be made of the semi-cured material or the cured material. The reinforcing portion 120 may be disposed on the carrying portion 110a. The fiber-resin composite material may include an aramid fiber woven fabric layer 111 and a resin composite layer 112. The aramid fiber woven fabric layer 111 may include 1 to 5 stacked layers of aramid fiber woven fabric, the aramid fiber woven fabric layer 111 may have the grammage in the range of 100 g/m² to 350 g/m², and the resin composite layer 112 may have the Shore hardness in the range of 80 A to 80 D.

A method for manufacturing the fiber-resin composite material may refer to the above embodiments. In some embodiments, the aramid fiber woven fabric layer 111 may include 1 layer to 3 stacked layers of aramid fiber woven fabric, the aramid fiber woven fabric layer 111 may have the grammage of 300±50 g/m², and the resin composite layer 112 may have the Shore hardness of 80 A to 50 D. Alternatively, the aramid fiber woven fabric layer 111 may include 3 stacked layers to 5 stacked layers of aramid fiber woven fabric, the aramid fiber woven fabric layer 111 may have the grammage of 150±15 g/m², and the resin composite layer 112 may have the Shore hardness of 90 A to 65 D.

Specifically, as shown in FIG. 7, the fiber-resin composite material may include the aramid fiber woven fabric layer 111 and the resin composite layer 112. The aramid fiber woven fabric layer 111 may have 2 stacked layers, the grammage of the aramid fiber woven fabric layer 111 may be 300±50 g/m², and the resin composite layer 112 may have the Shore hardness of 80 A. Of course, FIG. 7 is only one schematic representation. Depending on the degree of impregnation, the finished product may not have an obvious layered configuration of the aramid fiber woven fabric layer 111 and the resin composite layer 112. The resin composite layer 112 may be TPE resin.

As shown in FIG. 8, the fiber-resin composite material may include the aramid fiber woven fabric layer 111 and the TPU resin composite layer 113. The aramid fiber woven fabric layer 111 may have 4 stacked layers, the grammage of the aramid fiber woven fabric layer 111 may be 150±15 g/m², and the TPU resin composite layer 113 may have the Shore hardness of 90 A. Of course, FIG. 8 is only one schematic representation. Depending on the degree of impregnation, the finished product may not have an obvious layered configuration between the aramid fiber woven fabric layer 111 and the TPU resin composite layer 113.

Based on the above technical solutions, various materials may be obtained as the composite layer for the fiber-resin composite material, allowing the hardness of the fiber-resin composite material to be adjustable according to requirements. Therefore, the wrapping portion 110b of the body portion 110 made of the fiber-resin composite material may better wrap the sides of the phone and may further facilitate the phone to be inserted into or removed out of the body portion 110.

Tests were conducted on the wrapping portion of the mobile phone case shown in each of FIG. 7 and FIG. 8, compared with an aramid fiber mobile phone case available on the market made using epoxy resin impregnation. According to laboratory tests, the Shore hardness of the mobile phone case in FIG. 7 may be 50 D, the Shore hardness of the mobile phone case in FIG. 8 may be 75 D, and the Shore hardness of the mobile phone case in the market may be 92 D. While basic protective properties such as wrapping and wear resistance are satisfied, the wrapping portion of the mobile phone case of the present disclosure may be softer, and the phone may be removed more easily.

The resin composite layer 112 may be TPE resin or TPU resin. The reinforcing portion 120 may be formed of the semi-cured material, and the reinforcing portion 120 may be a fiberglass board. Alternatively, the reinforcing portion 120 may be formed of the cured material, and the reinforcing portion 120 may be a carbon fiber board, a stainless steel board, or a rigid polymer material such as a PC board. A method for combining the reinforcing portion 120 with the body portion 110 may refer to the above method for manufacturing the mobile phone case. By arranging the reinforcing portion 120, the strength of the carrying portion 110a may be improved.

Since, for the mobile phone case 100 of the present disclosure, the fiber-resin composite material may be obtained as the raw material for the body portion 110, the wrapping portion 110b of the body portion 110 may have ideal flexibility. The wrapping portion 110b may be deformed when the phone is installed into or removed from the body portion 110, such that the phone may be easily installed into or removed out of the mobile phone case 100. In addition, when the phone is installed in the body portion 110, the wrapping portion 110b may conform to and wrap the corresponding sides of the phone. Furthermore, the carrying portion 110a of the body portion 110 may be compounded with the reinforcing portion 120, ensuring the strength of the mobile phone case 100 at the position contacting the rear of the phone.

According to the method for manufacturing the fiber-resin composite material of the present disclosure, an aramid fiber woven fabric, having a grammage of 100 g/m² to 350 g/m² may be used as a base material, and a resin, having the Shore hardness in a range of 30 A to 85 D, may be used as a composite layer. Full pre-impregnation or semi-pre-impregnation may be performed on the base material and the composite layer, so as to form a semi-finished fiber-resin composite material. The semi-finished fiber-resin composite material may be hot-pressed in a hot pressing device and cooled to form a finished fiber-resin composite material. The fiber-resin composite material manufactured by the above method may have ideal strength and flexibility. For a mobile phone case manufactured using the above fiber-resin composite material, a bottom plate and four side plates may be integrally formed with each other and provide full coverage, such that four sides of the phone may be completely wrapped. Furthermore, the fiber-resin composite material may have certain flexibility, facilitating the phone to be installed into and removed out of the mobile phone case. In addition, the fiber-resin composite material may have ideal wear resistance, ensuring a service life of the mobile phone case.

Finally, it should be noted that the above embodiments are only used to illustrate, not to limit, the technical solutions of the present disclosure. Although the present disclosure is described in detail with reference to the above embodiments, any ordinary skilled artisan in the art shall understand that they can still modify the technical solutions described in the above embodiments or equivalently replace some of the technical features therein. The modifications or replacements do not cause the essence of the corresponding technical solutions to deviate from the spirit and scope of the technical solutions of the embodiments of the present disclosure.

1. A method for manufacturing a fiber-resin composite material, comprising:
obtaining an aramid fiber woven fabric as a base material, wherein the aramid fiber woven fabric has a grammage in a range of 100 g/m² to 350 g/m², and the aramid fiber woven fabric has N stacked layers, the N is a positive integer greater than or equal to 1;
obtaining a resin having a Shore hardness in a range of 30 A to 85 D as a composite layer, and performing full pre-impregnation or semi-pre-impregnation on the composite layer and the base material, so as to obtain a semi-finished fiber-resin composite material;
placing the semi-finished fiber-resin composite material in a hot pressing device for hot pressing, enabling the resin to penetrate into gaps of the aramid fiber woven fabric, wherein a temperature of the hot pressing in the hot pressing device is in a range of 150° C. to 250° C., a pressure of the hot pressing is in a range of 40 bar to 55 bar, and a duration of the hot pressing is in a range of 2 min to 10 min;
after the hot pressing performed on the semi-finished fiber-resin composite material for a preset hot pressing duration, stopping heating the semi-finished fiber-resin composite material, so as to obtain a finished fiber-resin composite material.

2. The method according to claim 1, wherein, a value of the Nis negatively correlated with the grammage of the aramid fiber woven fabric, and 1≤N≤5.

3. The method according to claim 2, wherein,
the aramid fiber woven fabric has a grammage of 300±50 g/m², the aramid fiber woven fabric has 1 layer to 3 stacked layers, and the composite layer is a resin having a Shore hardness in a range of 80 A to 50 D.

4. The method according to claim 2, wherein,
the aramid fiber woven fabric has a grammage of 150±15 g/m², the aramid fiber woven fabric has 3 stacked layers to 5 stacked layers, and the composite layer is a resin having a Shore hardness of 90 A to 65 D.

5. The method according to claim 1, wherein, the composite layer is a resin having a Shore hardness of 80 A to 80 D; and for the finished fiber-resin composite material, a thickness of each of the N stacked layers is in a range of 0.15 mm to 1 mm.

6. The method according to claim 1, wherein, the obtaining the resin having the Shore hardness in the range of 30 A to 85 D as a composite layer and performing semi-pre-impregnation on the composite layer and the base material, so as to obtain the semi-finished fiber-resin composite material, comprises:
obtaining a resin having a Shore hardness in a range of 30 A to 85 D as the composite layer, and stacking the composite layer with the aramid fiber woven fabric;
performing semi-pre-impregnation, using a hot pressing roller, on the stacked composite layer and aramid fiber woven fabric, so as to obtain the semi-finished fiber-resin composite material.

7. The method according to claim 1, wherein, the obtaining the resin having the Shore hardness in the range of 30 A to 85 D as a composite layer and performing full pre-impregnation on the composite layer and the base material, so as to obtain the semi-finished fiber-resin composite material, comprises:
obtaining a resin having a Shore hardness in a range of 30 A to 85 D as the composite layer, melting the composite layer and placing the melted composite layer in a pre-impregnation apparatus; and
placing the aramid fiber woven fabric in the pre-impregnation apparatus for full pre-impregnation, so as to obtain the semi-finished fiber-resin composite material.

8. A method for manufacturing a mobile phone case, comprising:
obtaining a fiber-resin composite material as a first sheet material;
cutting the first sheet material to obtain a preset sheet material in a preset size and in a preset shape, wherein, the preset sheet material comprises a central region and an edge region surrounding the central region;
obtaining a semi-cured material or a cured material as a second sheet material, attaching the second sheet material to the central region of the preset sheet material, and placing the second sheet material together with the preset sheet material into a mobile phone case mold;
performing secondary molding on the second sheet material and the preset sheet material, wherein a temperature of the secondary molding is in a range of 160° C. to 200° C., a pressure of the secondary molding is in a range of 35 bar to 45 bar, and a duration of the secondary molding is in a range of 5 min to 15 min;
after the duration of the secondary molding performed on the second sheet material and the preset sheet material reaching a preset molding duration, cooling the second sheet material and the preset sheet material to a room temperature, so as to obtain a finished mobile phone case;
wherein, the fiber-resin composite material is manufactured by:
obtaining an aramid fiber woven fabric as a base material, wherein the aramid fiber woven fabric has a grammage in a range of 100 g/m² to 350 g/m², and the aramid fiber woven fabric has N stacked layers, the N is a positive integer greater than or equal to 1;
obtaining a resin having a Shore hardness in a range of 30 A to 85 D as a composite layer, and performing full pre-impregnation or semi-pre-impregnation on the composite layer and the base material, so as to obtain a semi-finished fiber-resin composite material;
placing the semi-finished fiber-resin composite material in a hot pressing device for hot pressing, enabling the resin to penetrate into gaps of the aramid fiber woven fabric, wherein a temperature of the hot pressing in the hot pressing device is in a range of 150° C. to 250° C., a pressure of the hot pressing is in a range of 40 bar to 55 bar, and a duration of the hot pressing is in a range of 2 min to 10 min;
after the hot pressing performed on the semi-finished fiber-resin composite material for a preset hot pressing duration, stopping heating the semi-finished fiber-resin composite material, so as to obtain a fiber-resin composite material.

9. The method according to claim 8, wherein, a value of the N is negatively correlated with the grammage of the aramid fiber woven fabric, and 1≤N≤5.

10. The method according to claim 9, wherein,
the aramid fiber woven fabric has a grammage of 300±50 g/m², the aramid fiber woven fabric has 1 layer to 3 stacked layers, and the composite layer is a resin having a Shore hardness in a range of 80 A to 50 D.

11. The method according to claim 9, wherein,
the aramid fiber woven fabric has a grammage of 150±15 g/m², the aramid fiber woven fabric has 3 stacked layers to 5 stacked layers, and the composite layer is a resin having a Shore hardness of 90 A to 65 D.

12. The method according to claim 8, wherein, the obtaining the resin having the Shore hardness in the range of 30 A to 85 D as the composite layer, and performing semi-pre-impregnation on the composite layer and the base material, so as to obtain the semi-finished fiber-resin composite material, comprises:
obtaining a resin having a Shore hardness in a range of 30 A to 85 D as the composite layer, and stacking the composite layer with the aramid fiber woven fabric;
performing semi-pre-impregnation, using a hot pressing roller, on the stacked composite layer and aramid fiber woven fabric, so as to obtain the semi-finished fiber-resin composite material.

13. The method according to claim 8, wherein, the obtaining the resin having the Shore hardness in the range of 30 A to 85 D as the composite layer, and performing full pre-impregnation on the composite layer and the base material, so as to obtain the semi-finished fiber-resin composite material, comprises:
obtaining a resin having a Shore hardness in a range of 30 A to 85 D as the composite layer, melting the composite layer and placing the melted composite layer in a pre-impregnation apparatus; and
placing the aramid fiber woven fabric in the pre-impregnation apparatus for full pre-impregnation, so as to obtain the semi-finished fiber-resin composite material.

14. The method according to claim 8, wherein,
the second sheet material is formed of the semi-cured material, and the second sheet material is a fiberglass board.

15. The method according to claim 8, wherein the second sheet material is formed of the cured material, and the second sheet material is a carbon fiber board, a stainless steel board, or a PC board.

16. A mobile phone case, comprising: a body portion made of a fiber-resin composite material and a reinforcing portion made of a semi-cured material or a cured material,
wherein, the body portion comprises a carrying portion for contacting a rear of a phone and a wrapping portion for wrapping sides of the phone; the reinforcing portion is disposed on the carrying portion; the fiber-resin composite material comprises an aramid fiber woven fabric layer and a resin composite layer; the aramid fiber woven fabric layer comprises 1 layer to 5 stacked layers of aramid fiber woven fabric, the aramid fiber woven fabric layer has a grammage in a range of 100 g/m² to 350 g/m², and the resin composite layer has a Shore hardness in a range of 80 A to 80 D.

17. The mobile phone case according to claim 16, wherein,
the aramid fiber woven fabric layer comprises 1 layer to 3 stacked layers of aramid fiber woven fabric, the aramid fiber woven fabric layer has a grammage of 300±50 g/m², and the resin composite layer has a Shore hardness of 80 A to 50 D.

18. The mobile phone case according to claim 16, wherein,
the aramid fiber woven fabric layer comprises 3 stacked layers to 5 stacked layers of aramid fiber woven fabric, the aramid fiber woven fabric layer has a grammage of 150±15 g/m², and the resin composite layer has a Shore hardness of 90 A to 65 D.

19. The mobile phone case according to claim 16, wherein,
the resin composite layer is TPE resin or TPU resin; the reinforcing portion is formed of the semi-cured material, and the semi-cured material is a fiberglass board.

20. The mobile phone case according to claim 16, wherein,
the reinforcing portion is formed of the cured material, and the cured material is a carbon fiber board, a stainless steel board, or a PC board.
